(19) United States
(12) Patent Application Publication
(10) Pub. No.: US 2011/0214331 A1
(43) Pub. Date: Sep. 8, 2011

(54) ICE FISHING TIP-DOWN

(76) Inventors: John A. O'Leary, Humbird, WI (US); Michael R. Bemis, Humbird, WI (US)

(21) Appl. No.: 12/963,171

(22) Filed: Dec. 8, 2010

Related U.S. Application Data
(60) Provisional application No. 61/309,675, filed on Mar. 2, 2010.

(51) Int. Cl. A01K 97/11; A01K 97/12; A01K 97/01

(52) U.S. Cl. 43/16

(57) ABSTRACT

The present disclosure relates to tip-down devices used in fishing and particularly adapted for use in ice fishing. In various exemplary embodiments, the tip down includes a pivoting rod holder wherein the fishing rod pivots between two positions and automatically moves away from intermediate positions, the two positions differing in the tip of the fishing rod being held upward or downward. In various exemplary embodiments, the disclosed tip-down includes a line clip, which is used to temporarily hold the fishing line in place (e.g., at a point between the reel and the first eye of the fishing rod). The disclosed tip-down the fishing rod to be set up in a way that allows a fish to take the bait and attempt to swim away without resistance from the fishing line or rod while still indicating a strike and allowing the user, who may be remote from the fishing rod, time to respond.

### PRIORITY

This application claims priority to U.S. Provisional Application No. 61/309,675 filed Mar. 2, 2010, which is incorporated herein by reference in its entirety.

### BACKGROUND

1. Field of the Invention

The present invention relates to devices used to hold fishing poles. More particularly, it relates to a device used for ice fishing that holds a fishing pole, indicates a strike by tipping down, and releases the fishing line.

2. Related Art

As with other forms of fishing, an ice fisherman is alerted to a fish taking his bait by the fishing rod end tipping downward. This is caused by the fish pulling on the bait and the fishing line. Various devices have been devised to hold a fishing rod in place and signal a fish strike or bite. One type is generally referred to as a tip-up and provides a flag or similar signal that is caused to go up when a bite is felt on the line. A second type is generally referred to a tip-down. A tip-down allows the fishing rod to move from pointing somewhat upward to somewhat downward using the downward force of the fish strike to move the rod.

### Outline of Basic and Other Advantageous Features

It would be desirable to provide a fishing rod mounting or the like of a type disclosed in the present application that includes any one or more of these or other advantageous features:
A tip-down that releases the line as soon as the pole is tipped down;
A tip-down that allows line to be released as the fish swims rather than pulling the bait away from the fish; and
A tip-down that is easily stored and transported.

### SUMMARY

An exemplary embodiment relates to a tip-down, comprising a pivoting support structure for holding a fishing pole and a fishing line clamp wherein the pivoting support structure is capable of pivoting between an up position and a down position and wherein a tip of a fishing pole in the pivoting support structure would be noticeably higher in the first position than the tip would be in the second position.

These and other features and advantages of various embodiments of systems and methods according to this invention are described in, or are apparent from, the following detailed description of various exemplary embodiments of various devices, structures, and/or methods according to this invention.

### BRIEF DESCRIPTION OF THE DRAWINGS

Various exemplary embodiments of the systems and methods according to the present disclosure will be described in detail, with reference to the following figures, wherein:

FIG. 1 is a front perspective view of an exemplary embodiment of a tip-down according to the present disclosure;

FIG. 2 is a front view of the embodiment of FIG. 1 with a fishing pole in a tipped-up position;

FIG. 3 is a front view of the embodiment of FIG. 1 with a fishing pole in an intermediate position between a tipped-up position and tipped-down position;

FIG. 4 is a front view of the embodiment of FIG. 1 with a fishing pole in a tipped-down position; and

FIG. 5 is a from view of an exemplary embodiment of a pivot plate for a tip-down according to the present disclosure.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

With conventional tip-downs, the hook and line can move to the extent the pole is allowed to move. Once the rod is down, the fish cannot pull the bait further unless it is strong enough to overcome the resistance of the fishing reel to turning. However, this resistance is generally not strong enough to set the hook in the mouth of the fish so it is necessary for the fisherman to react quickly to a strike by taking the fishing rod and setting the hook. Because ice fishing of necessity is done in cold weather on the surface of a frozen water body, the fisherman may be in a warmer location (e.g., a portable but or a vehicle) rather than near the pole. In addition to removing the necessity to constantly hold the pole, such devices allow a single fisherman to fish with multiple poles in different holes.

With a and conventional tip-down, after the pole has tipped down the bait cannot easily be pulled further and may be pulled away from the fish's mouth as it swims away. When a fish strikes the bait, initially the hook is often not deep into the fish's mouth. If the hook is not set into the fish's mouth, the fish may escape. To set the hook, a fisherman will give the pole a hard, fast yank. With conventional tip-downs, the line will limit where a fish may take the bait, but the force from a fish pulling the bait away from the pole is rarely enough to set the hook and the fish may release the bait and hook in response to the pull of the line on the bait. This combination of factors creates a small window of opportunity for the fisherman to react and set the hook, which time may be too short if the user is tending another pole or for any other reason not close enough to the pole and tip-down. Because of this, many fish strikes do not result in the fish being hooked and caught.

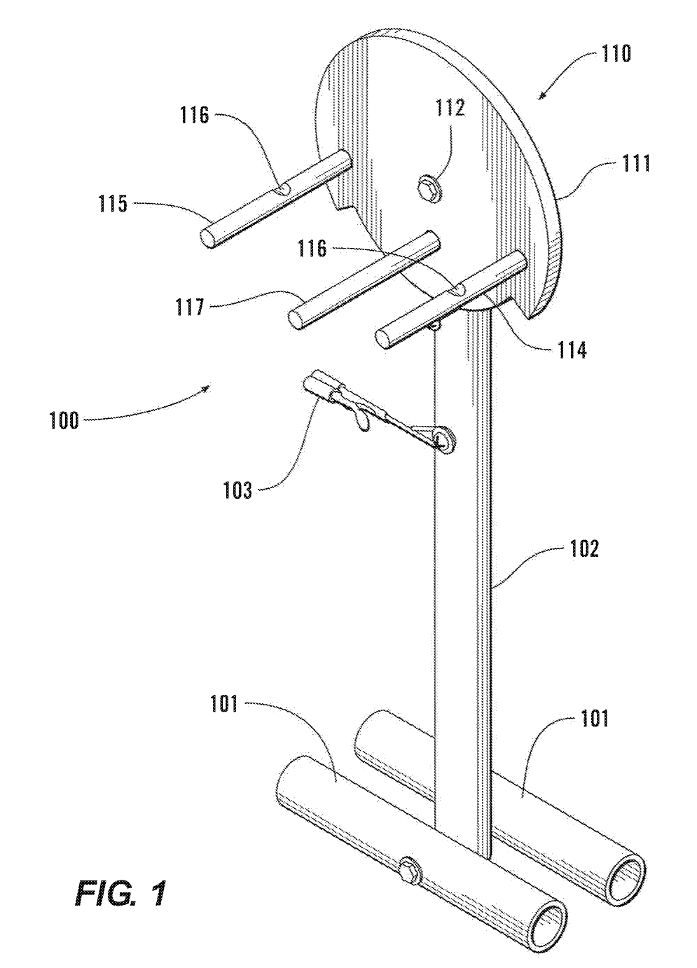

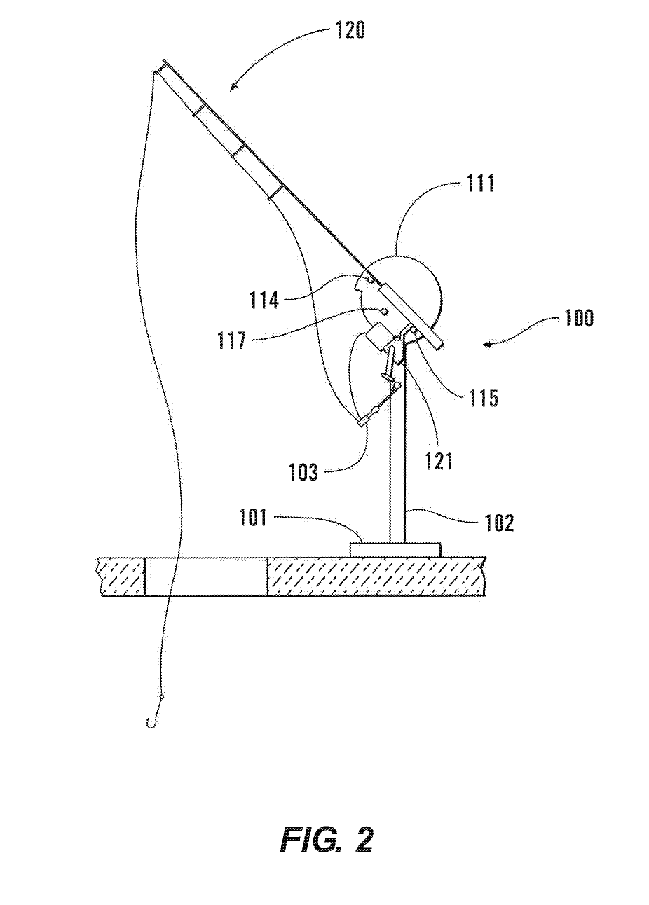

In various exemplary embodiments, as shown in FIG. 1, tip-down 100 includes a base 101, a support member 102, and a pivoting support structure 110. In various exemplary embodiments, the pivoting support structure 110 includes a plate 111 that is pivotally connected to the support member 102. The plate 111 pivots between two different positions, referred to herein as an up position and a down position. In the up position, a fishing pole 120 placed in the tip-down 100 is pointed somewhat upward, as illustrated in FIG. 2. In the down position, a fishing pole 120 placed in the tip-down 100 is pointed somewhat downward, as illustrated in FIG. 4. In various exemplary embodiments, the pivot plate 111 is attached to the support member 102 such that it pivots around a point 112 (“pivot point”) other than its center of mass (“center point”). For example, the pivot point 112 may be located somewhat above or below the center point. In such exemplary embodiments, the force of gravity will pull the pivot plate 111 toward either the up position or the down position. No precise pivot point 112 is required and the choice of where to place the pivot point 112 will also be affected by the weight of the plate 111, the weight of the pole 120, and the location of the support pegs 114 and 115 and reel support peg 117.

In various exemplary embodiments, as shown in FIG. 1, three pegs extend from the pivot plate 111: a front support peg 114, a back support peg 115, and a reel support peg 117. As shown in FIG. 1, the front and back support pegs 114 and 115 are placed further from the center of the pivot plate 111. In various exemplary embodiments, as shown in FIGS. 2-4, the fishing pole is placed on and supported by the two support pegs 114 and 115 with the front support peg 114 closer to the tip of the pole and the back support peg 115 closer to the bottom or handle of the pole 120 (shown in FIGS. 2-4). In various exemplary embodiments, the reel support peg 117 is placed roughly between the support pegs 114 and 115, but below an imaginary line passing through the front and back support pegs 114 and 115. In various exemplary embodiments, the reel support peg 117 may be centered between the support pegs 114 and 115 or be somewhat closer to one or the other support peg 114 or 115. It should be appreciated that the designation of the support pegs 114 and 115 as front and hack is for the purpose of aiding in the description of the use of the device. A pole 120 (shown in FIGS. 2-4) may placed as shown in the drawings or its direction may be reversed with the front support peg 114 functioning as the back support peg 115 and vice versa. A fishing pole 120 may be oriented in either direction as desired (e.g., so that the handle of the reel 121 (shown in FIGS. 2-4) is away from the plate 111). Reversing the orientation of the tip-down 110 permits the tip-down 110 to be used with the pole 120 to either the right-hand or left-hand side.

In various exemplary embodiments, one or both of the support pegs 114 and 115 include a groove 116 into which the fishing rod 120 is placed. The groove(s) 116 provide greater stability to the fishing rod 120 while in the tip-down 100, which may be particularly important in harsh weather (e.g., wind or storms) or during a powerful fish strike.

As shown in FIG. 2, a fishing pole 120 is placed on the tip-down 100 by resting the pole 120 on the support pegs 114 and 115 with the reel 121 preferably between the support pegs 114 and 115. The reel is preferably located between the reel support peg 117 and the back support peg 115, but may be placed to either side of the reel support peg 117. In the preferred position, the reel rests against the back support peg 115 when in the up position and, the reel conies to rest against the reel support peg 117 when in the down position. In various exemplary embodiments, the reel may instead be placed between the reel support peg 117 and the front support peg 114 and the choice may depend in part on the length and weight of the pole 120 being used.

In various exemplary embodiments, the plate 111 is pivotally coupled to the support leg such that the plate 111 will remain in the up position until a downward force is applied. The plate 111 will also remain in the down position until an upward force is applied. In various exemplary embodiments, the plate 111 is most stable in the extreme positions (i.e., toward the up and down positions) and tends to pivot away from an intermediary position. This may be accomplished by locating the pivot point 112 away from the pivot plate's center of gravity.

In various exemplary embodiments, as shown in FIGS. 2-4, a stop 104 projects from the support leg 102 just below the pivot plate 111. The plate 111 is shaped such that it comes into contact with a stop 104 at the up position and down position, which prevents the pivot plate 111 from pivoting too far in either direction.

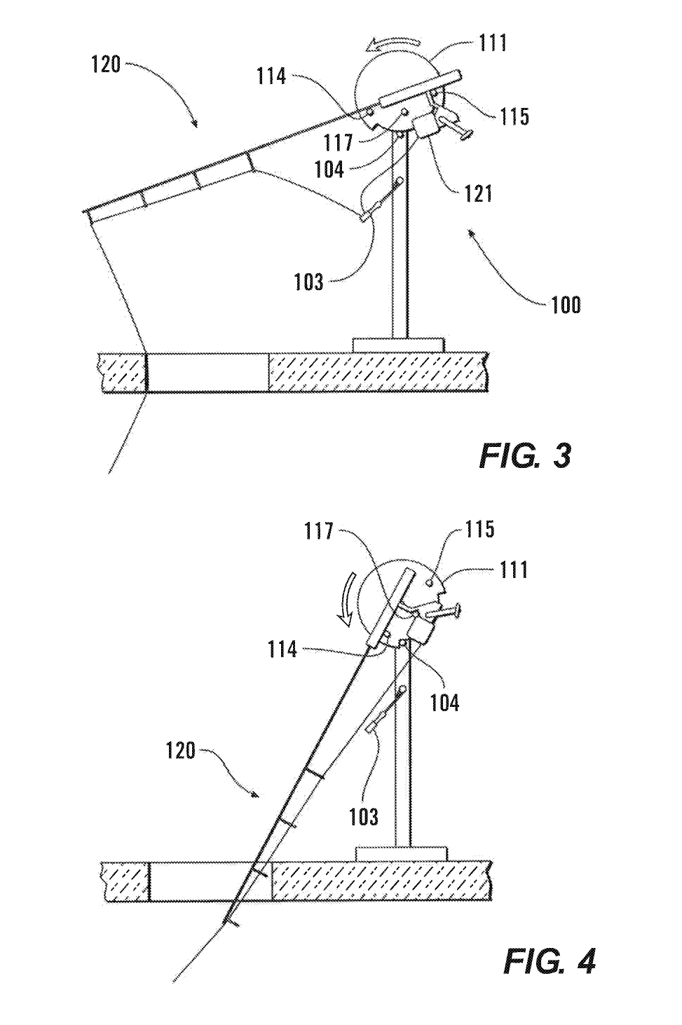

In various exemplary embodiments, as shown in FIGS. 1-4, the tip-down 100 also includes a line clamp 103, FIG. 2 shows the line clamp 103 and reel as positioned while waiting for a fish strike. The tip-down 100 is in the up position and the reel is open, but line is not released because it is held in place by the lime clamp 103. When a fish strikes, the pole is pulled downward and the pivot plate 111 rotates from the up toward the down position, as illustrated by FIG. 3.

FIG. 3 shows the tip-down 100 immediately following a fish strike. The pivot plate 111 has rotated to or very near to the down position. The line is shown still held by the line clamp 103, but the force of the fish strike will pull the line free of the line clamp 103 at least by the time the pivot plate 111 is fully rotated to the down position, as shown in FIG. 4. In various exemplary embodiments, the line clamp 103 is oriented pointed significantly more downward than horizontal. With a conventional tip-down 100, the reel would be closed and the fish would feel resistance from the bait. In various exemplary embodiments of the disclosed tip-down 100, the fish will not feel any significant resistance from the bait because the reel is open and will be much less likely to lose the bait. At this point, the user can see that a fish strike has occurred and can react appropriately.

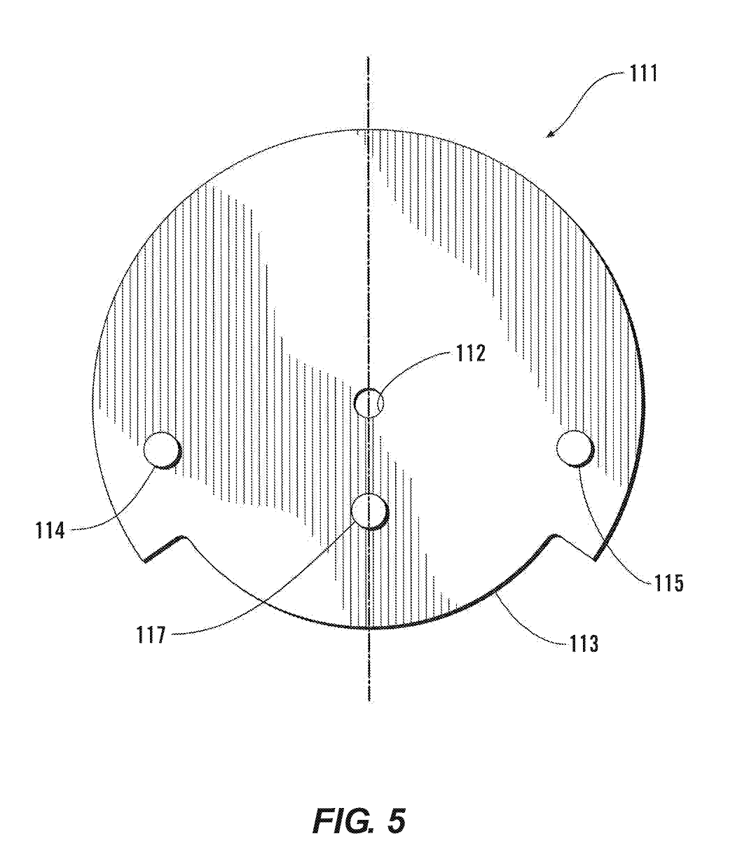

FIG. 5 shows an exemplary embodiment of a pivot plate 111. In various exemplary embodiments, the pivot plate 111 is generally symmetrical around vertical axis 118, which passes through pivot point 112, in various embodiments, the pivot plate 111 includes a cut-out or slot 113. As shown in FIGS. 3-4, slot 113 interacts with stop 104 to control the extent to which the pivot plate 111 can rotate.

In various exemplary embodiments, the base 101 comprises one or more horizontal pieces. In various exemplary embodiments, the base, pieces rotate relative to the support leg so that they are parallel to the support leg. This makes it easier to store or transport the tip-down 100 (e.g., ice fishermen often transport equipment in buckets). In various exemplary embodiments, the tip-down 100 includes a mechanism to lock the base pieces in place relative to the support leg in the open (i.e., in use) and/or closed (i.e., for storage) position. In various exemplary embodiments, the tip-down 100 may include additional pieces attached to the support leg or base pieces to provide additional support and stability, which may be beneficial when a fish strikes or in windy conditions.

In various exemplary embodiments, the tip-down 100 may be used left-handed or right-handed. In other words, the tip-down 100 may be rotated so that, from the perspective of the user, the rod may be placed to the right or to the left of the pivot plate 111. Thus, either support peg may be the front or the back support peg, depending on how the pole is oriented.

Although the tip-down has been described in connection with ice fishing, in various exemplary embodiments, the tip-down may be used for fishing at any time of year. For example, the tip-down may be used for shoreline fishing. The tip-down is used as described after casting. In such uses, the tip-down will function as described and allow a striking fish to draw out fishing line without significant resistance until the user intervenes. In various exemplary embodiments, the tip-down may be used with a variety of fishing rods from very short ones to rods at least as long as six feet.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that references to relative positions (e.g., “top” and “bottom”) in this description are merely used to identify various elements as are oriented in the figures. It should be recognized that the orientation of particular components may vary greatly depending on the application in which they are used.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It is also important to note that the construction and arrangement of the tip-down, as shown in the various exemplary embodiments, is illustrative only. While the tip-down, according to this invention, has been described in conjunction with the exemplary embodiments outlined above, various alternatives, modifications, variations, improvements, and/or substantial equivalents, whether known or that are or may be presently unforeseen, may become apparent. Accordingly, the exemplary embodiments of the tip-down, according to this invention, as set forth above, are intended to be illustrative, not limiting. Various changes may be made without departing from the spirit and scope of the invention. Therefore, the description provided above is intended to embrace all known or later-developed alternatives, modifications, variations, improvements, and/or substantial equivalents.

What is claimed is:

1. A tip-down, comprising:
a pivoting support structure for holding a fishing pole; and
a fishing line clamp;
wherein the pivoting support structure is capable of pivoting between an up position and a down position; and
wherein a tip of a fishing pole in the pivoting support structure would be noticeably higher in the up position than the tip would be in the down position.

2. The tip-down of claim 1 wherein the pivoting support structure comprises:
a pivot plate pivotally attached to a support member; and
at least two support pegs on the pivot plate.

3. The tip-down of claim 2 wherein the pivot plate is not attached to the tip-down at the pivot plate's center of mass.

4. The tip-down of claim 2 wherein the pivot plate is pivotally connected approximately on the vertical axis of the pivot plate.

5. The tip-down of claim 3 wherein the pivot plate is pivotally connected approximately on the vertical axis of the pivot plate.

6. The tip-down of claim 2 further comprising:
a first half of the pivot plate and a second half of the pivot plate wherein the pivot plate is divided into approximately equal halves along a vertical axis;
a first support peg on a first half of the pivot plate; and
a second support peg on a second half of the pivot plate.

7. The tip-down of claim 6 wherein the first support peg and second support peg form a line approximately perpendicular to the vertical axis.

8. The tip-down of claim 6 wherein the first support peg and second support peg are approximately the same distance from the vertical axis.

9. The tip-down of claim 7 wherein the first support peg and second support peg are approximately the same distance from the vertical axis.

10. The tip-down of claim 2 further comprising a stop peg on the pivot plate generally in an area between at least two support pegs.

11. The tip-down of claim 6 further comprising a stop peg on the pivot plate generally in an area between at least two support pegs.

12. The tip-down or claim 11 wherein the stop peg is located approximately on the vertical axis.

13. The tip-down or claim 2 wherein the at least two support pegs further comprise grooves.

14. The tip-down of claim 1 further comprising at least one base member pivotally attached to the support member.
